(19) United States
(12) Patent Application Publication
(10) Pub. No.: US 2006/0288837 A1
(43) Pub. Date: Dec. 28, 2006

(54) Surgical saw guide

(75) Inventors: Michael Utz, Tuttlingen (DE); Thomas Hermle, Rottweil (DE)

Correspondence Address: Lipsitz & McAllister, LLC, 755 MAIN STREET, MONROE, CT, 06468, US

(73) Assignee: AESCULAP AG & Co. KG, Tuttlingen (DE)

(21) Appl. No.: 11/449,034

(22) Filed: Jun. 6, 2006

(30) Foreign Application Priority Data
Jun. 10, 2005 (DE) 10 2005 026 789.0

(51) Int. Cl. B26D 5/08

(52) U.S. Cl. 83/574

(57) ABSTRACT

In a surgical saw guide comprising a guide body having a front side for placement on a body structure, an opposite rear side, and a guide slot for a saw blade, which extends through the guide body from the rear side to the front side thereof and is delimited at the sides, in order to enlarge the cutting area that can be reached by the saw blade and nevertheless ensure a reliable guidance of the saw blade in the guide slot, it is proposed that the guide slot be open at the sides at least at one end on the front side of the guide body.

The present disclosure relates to the subject matter disclosed in German application number 10 2005 026 789.0 of Jun. 10, 2005, which is incorporated herein by reference in its entirety and for all purposes.

### BACKGROUND OF THE INVENTION

The invention relates to a surgical saw guide comprising a guide body having a front side for placement on a body structure, an opposite rear side, and a guide slot for a saw blade, which extends through the guide body from the rear side to the front side thereof and is delimited at the sides.

In surgical operations it is often necessary to prepare a bone for placement of a joint replacement implant thereon. It is standard practice to remove parts of the bone with an oscillating saw so as to produce flat surfaces for placement of the implant thereon. It is extremely important for the saw blades to be guided exactly when making these cuts. To achieve this, saw guides of the generic kind are used, in which the saw blades project through the guide slot and are guided therein, thereby bearing on the top side and the bottom side of the guide slot. To ensure reliable guidance, it is necessary for the spacing between the front side and the rear side of the guide body to be as large as possible so as to produce a deep slot which guides the saw blade of the oscillating saw over as great a length as possible (DE 10 2004 028 690 A1).

On the other hand, this large depth of the guide slot results in the sideways swivability of the saw blade and, consequently, the area of the bone reachable by the saw blade, being limited. This is particularly disadvantageous when, for example, the instruments are to be reduced in size for minimally invasive operating procedures where, for example, a narrower guide body is to be used.

The object of the invention is to so design a generic saw guide that with it, on the one hand, a reliable guidance of the saw blade is ensured, while, on the other hand, as large an area as possible at the front side of the saw blade is reachable by a saw blade guided in the guide slot.

### SUMMARY OF THE INVENTION

This object is accomplished in a surgical saw guide of the kind described at the outset, in accordance with the invention, in that the guide slot is open at the sides at least at one end on the front side of the guide body.

The side opening of the guide slot allows the saw blade to protrude out of this side opening on the front side of the saw guide, with the result that the swivel range that can be covered by the saw blade is increased. Nevertheless, a good guidance of the saw blade is maintained, as the depth of the guide slot is not reduced at all or is only slightly reduced by the side opening of the guide slot.

It may be provided that the side opening at the end of the guide slot extends at least over 30% of the depth of the guide slot. In particularly advantageous cases, this may also constitute a larger proportion of the depth of the guide slot, for example, up to 60%.

In accordance with a preferred embodiment, the side opening at the end of the guide slot may be formed by a recess of the guide body.

This may correspond in its height to the height of the guide slot, in which case the guide slot extends in the area of the side opening as far as the outer contour of the guide body, and the outer contour of the guide body otherwise remains unaltered over the entire height.

It is, however, also possible for the height of the recess to exceed the height of the guide slot and, in particular, the recess may extend over the entire height of the guide body.

It is particularly advantageous for the recess to be formed by a step in the front side of the guide body. In such a configuration, the guide body has a relatively large thickness over its entire width and, consequently, a consistently large depth of the guide slot. Only at the side edge areas is the guide slot opened by the stepped recess, and only in this area is the thickness of the guide body reduced. Owing to the consistent depth of the guide slot over the entire width of the guide slot, with the exception of the edge areas, a reliable guidance of the saw blade in the guide slot over the entire width is thereby also ensured.

In a preferred embodiment of the saw guide, the spacing between front side and rear side may be smaller towards the side ends of the guide slot than in the central area of the guide slot. This may be achieved by, for example, the front side of the guide body towards the side edges thereof extending, for example, at a slant at the sides of the guide body, in the direction towards the rear side.

The following description of preferred embodiments of the invention serves in conjunction with the drawings to explain the invention in greater detail.

### BRIEF DESCRIPTION OF THE DRAWINGS

FIG. 1 shows a perspective view of a saw guide with a guide slot which is partially open at the side;

FIG. 2 shows a perspective view of the saw guide of FIG. 1 in the direction of arrow A in FIG. 1;

FIG. 3 shows a sectional view along line 3-3 in FIG. 1;

FIG. 4 shows a perspective view of a further preferred embodiment of a saw guide; FIG. 5 shows a perspective view of the saw guide of FIG. 4 in the direction of arrow B in FIG. 4; and

FIG. 6 shows a sectional view along line 6-6 in FIG. 5.

### DETAILED DESCRIPTION OF THE INVENTION

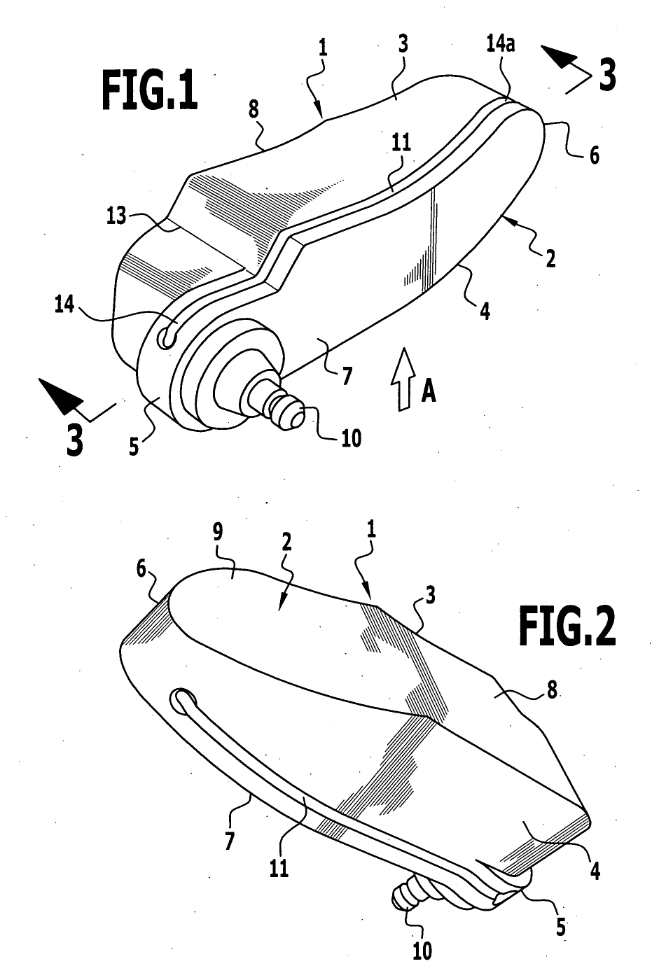

The saw guide 1 represented in FIGS. 1 to 3 comprises a solid guide body 2 having essentially the shape of a rectangular parallelepiped with a curved front side 3 and a curved rear side 4 extending substantially parallel thereto. The front side 3 and the rear side 4 pass over into one another via curved side walls 5, 6. The top side 7 and the bottom side 8 extend substantially parallel to each other and are of flat configuration. In the embodiment of FIGS. 1 to 3, the bottom side 8 has a slant 9 at one side thereof, whereas a holding pin 10, on which a marking element, not shown in the drawings, of a navigation system may be placed, protrudes upwards on the top side 7. The position and orientation of the saw guide 1 in space may be determined in a manner known per se by this navigation system.

A guide slot 11 extends through the guide body 2. The guide slot 11 runs from the rear side 4 to the front side 3 over substantially the entire guide body 2 parallel to the top side and the bottom side. In the area of the rounded-off side walls 5, 6, this guide slot is partially closed and partially open towards the side.

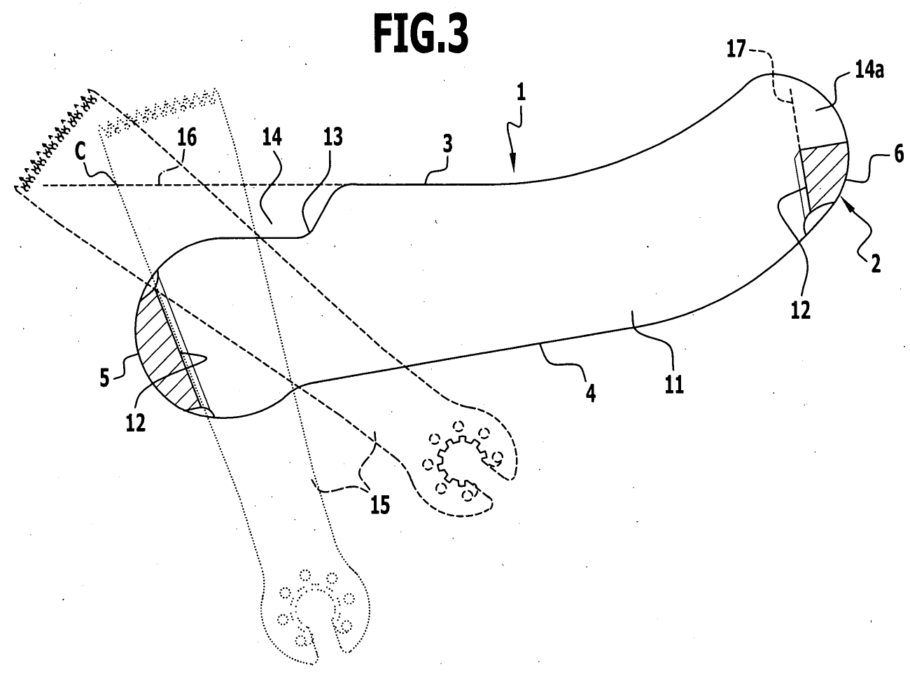

On one side of the embodiment shown in FIGS. 1 to 3, a closed side wall 12 of the guide slot 11 extends over substantially the entire guide body 2, but, in its edge area, the thickness of the guide body 2 is reduced by a stepped recess 13 in the front side 3, which produces a side opening 14 for the guide slot 11 (left-hand side of the saw guide 1 in FIG. 3) in the area of the step.

As will be apparent from the representation on the left-hand side of FIG. 3, a saw blade 15 inserted through the guide slot 11 and guided in it by bearing on the top side and the bottom side of the guide slot 11 can be made to pass through the guide slot 11 at a larger angle relative to the saw guide 1 by the side opening 14. This is represented by the saw blade 15 drawn in dashed lines. If the side opening 14 were missing, i. e., the guide slot 11 extended along the dashed line 16 following the course of the front side 3 without a recess 13 as far as point C, the saw blade 15 could be swiveled out less far sideways and, consequently, would reach a smaller area of the bone at the side,on which the saw guide 1 is placed with the front side 3. This is represented by the saw blade in dotted lines in FIG. 3.

Owing to the provision of the recess 13 and the resulting creation of the side opening 14 of the guide slot 11, it is thus made possible for the operator to reach a larger area of the adjacent bone at the side, while maintaining a consistently good guidance of the saw blade in the guide slot.

The side opening of the guide slot 11 in the embodiment of FIG. 3 is obtained on the one side by a recess 13 extending over the entire height of the guide body 2.

A side opening 14a is also provided on the opposite side, but this is formed by the guide slot 11 extending over approximately half of the thickness of the guide body 2 itself as far as the side wall 6. Accordingly, the side wall 17 delimiting the guide slot 11 at this side only extends from the rear side 4 of the guide body 2 as far as approximately the center of the guide body 2. In this case, the thickness of the guide body 2 and, therefore, the guiding capability of the guide slot 11 remain unaltered. Nevertheless, owing to the side opening 14a, in a similar way to that at the opposite end of the guide slot 11, a saw blade may reach a wider area of the bone at the side than in the case of a side wall 17 that would extend over the entire depth of the guide slot 11.

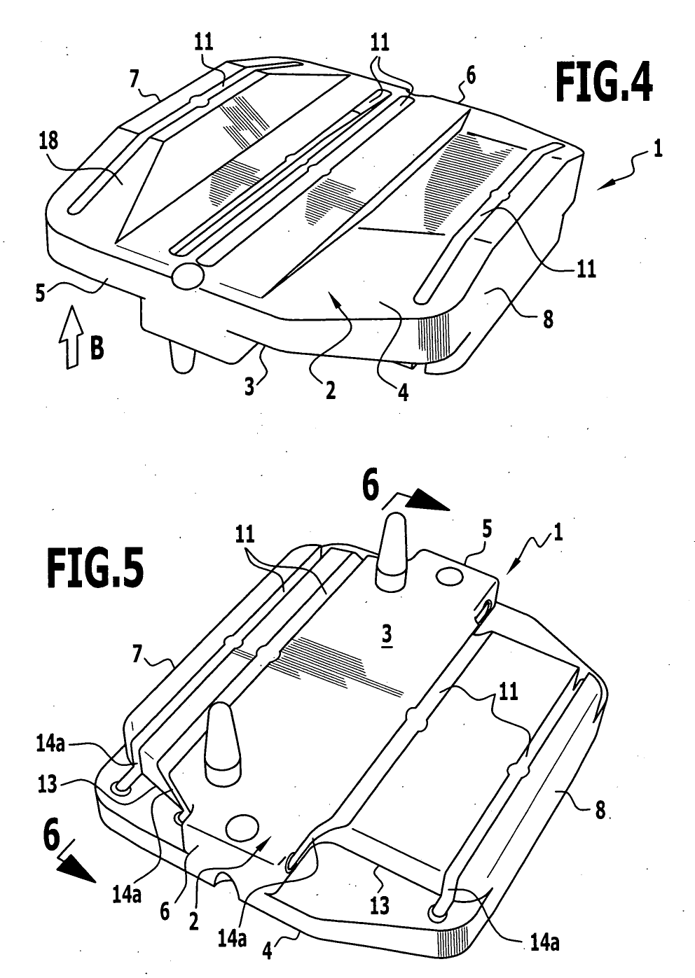

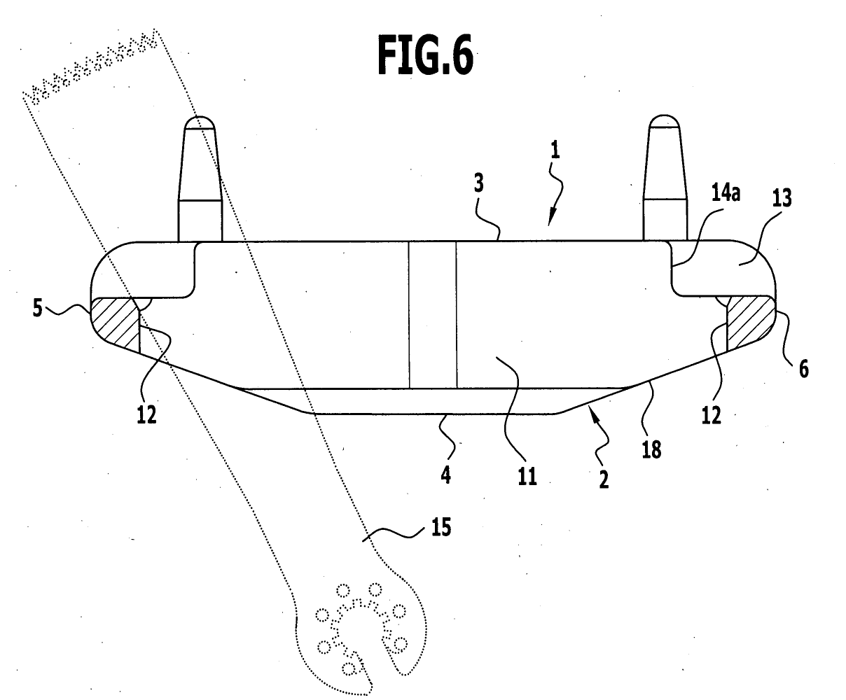

The construction chosen in the embodiment of a saw guide 1 according to FIGS. 4 to 6 is, in principle, similar. Therefore, corresponding parts bear the same reference numerals. In this saw guide 1, the guide body 2 has a larger height. The front side 3 is of substantially flat configuration, and the rear side 4 runs parallel to the front side 3 only in the central area, while the side areas 18 are slanted, so that the thickness of the guide body 2 at the side edges is less than at the center (FIG. 6).

A plurality of guide slots 11 are arranged in this guide body 2 so as to be distributed over its height. These run partly parallel to the top side and to the bottom side, but are partly also inclined in such a way that a saw blade guided in these guide slots points upwards at an incline or downwards at an incline.

In its edge area, the guide body 2 has a stepped recess 13 on either side thereof, which produces a side opening 14 for all guide slots 11 in a manner similar to that on the left-hand side of the embodiment of FIGS. 1 to 3. Consequently, all guide slots 11 are open at the side and towards the front side 3 of the guide body 2, whereas they are closed on the rear side 4. This configuration again results in a saw blade inserted in the guide slot being able to pass over a larger area of the bone bearing on the front side.

This effect is further increased by the side areas 18 extending at an incline on the rear side 4 of the guide body 2. In the embodiment shown, such a configuration is only provided in the area of the topmost guide slot 11. In this area, the material thickness of the guide body 2 is, therefore, substantially greater in the central area than in the edge area, with the result that the saw blade is guided there over an even larger depth than in the edge areas.

1. Surgical saw guide comprising a guide body having a front side for placement on a body structure, an opposite rear side, and a guide slot for a saw blade, said guide slot extending through said guide body from the rear side to the front side of said guide body, said guide slot being delimited at the sides by a respective side wall, and said guide slot being open at the sides at least at one end on the front side of said guide body.

2. Saw guide in accordance with claim 1, wherein the side opening at the end of the guide slot extends over at least 30% of the depth of the guide slot.

3. Saw guide in accordance with claim 1, wherein the side opening at the end of the guide slot is formed by a recess of the guide body.

4. Saw guide in accordance with claim 3, wherein the height of the recess corresponds to the height of the guide slot.

5. Saw guide in accordance with claim 3, wherein the height of the recess exceeds the height of the guide slot.

6. Saw guide in accordance with claim 5, wherein the recess extends over the entire height of the guide body.

7. Saw guide in accordance with claim 3, wherein the recess is formed by a step in the front side of the guide body.

8. Saw guide in accordance with claim 1, wherein the spacing between front side and rear side is smaller towards the side ends of the guide slot than in the central area of the guide slot.

9. Saw guide in accordance with claim 3, wherein the spacing between front side and rear side is smaller towards the side ends of the guide slot than in the central area of the guide slot.
